(19) United States
(12) Patent Application Publication
(10) Pub. No.: US 2025/0262918 A1
(43) Pub. Date: Aug. 21, 2025

(54) Vehicle Mounted Camouflage Shade Device and Method of Use

(71) Applicants: Abbey Ramos, Temecula, CA (US); Juan Ramos, Temecula, CA (US)

(72) Inventors: Abbey Ramos, Temecula, CA (US); Juan Ramos, Temecula, CA (US)

(21) Appl. No.: 18/768,148

(22) Filed: Jul. 10, 2024

Related U.S. Application Data
(60) Provisional application No. 63/555,422, filed on Feb. 20, 2024.

(51) Int. Cl. B60J 7/00; F41H 3/02

(52) U.S. Cl. CPC B60J 7/0023; F41H 3/02

(57) ABSTRACT

A vehicle mounted camouflage shade device designed for open-top vehicles, such as ATVs, UTVs, and Jeeps, including off-highway and on-highway vehicles alike, providing shade and protection from excessive sunlight is disclosed. The device features a multilayer construction with a top camouflage netting layer made of tear-resistant material and a base layer comprising a mesh liner and/or webbing in checkered pattern to allow air to pass there through. The layers are coupled and sewn together with a sturdy webbing frame, ranging from 1 inch to 5 inches in width. The shade device includes multiple attachment mechanisms such as straps with hook and loop, straps with adjustable buckles, grommets made of corrosion-resistant material, and bungees to ensure secure attachment to the vehicle. In one embodiment, the top camouflage-netting layer comprises multiple independent panels wherein each panel can be removed independently (i.e., selectively).

### CROSS-REFERENCE TO RELATED APPLICATION

The present application claims priority to, and the benefit of, U.S. Provisional Application No. 63/555,422, which was filed on Feb. 20, 2024, and is incorporated herein by reference in its entirety.

### FIELD OF THE INVENTION

The present invention generally relates to the field of shade devices for vehicles. More specifically, the present invention relates to a novel vehicle mounted camouflage shade device for open-top vehicles. The shade device has a multilayer construction with a top camouflage netting layer (2D or 3D) and a base layer (i.e., mesh netting layer) comprising a mesh liner and/or a webbing in a checkered pattern.

The layers are coupled and sewn together with a sturdy webbing frame. The device includes multiple attachment mechanisms including but not limited to straps with hook and loop, straps with adjustable buckles, grommets made of corrosion-resistant material, and bungees to ensure secure attachment to the vehicle. Accordingly, the present disclosure makes specific reference thereto. Nonetheless, it is to be appreciated that aspects of the present invention are also equally applicable to other like applications, devices, and methods of manufacture.

### BACKGROUND

By way of background, vehicles for on-highway and off-highway use such as Jeeps, UTVs, ATVs, and others of the like provide a unique experience with open roof areas in the vehicle and views for the travelers, however, there are several challenges faced by the occupants of the open roof vehicles. Vehicles such as Jeeps, UTVs, ATVs, and others of the like with an open top area are susceptible to inclement weather and individuals travelling within these vehicles must face consequences of all kinds of weather conditions such as sun, rain, wind, or the like. For example, in sunny weather, the individuals travelling in vehicles without a top area are exposed to harsh ultraviolet rays and are susceptible to sunlight damage causing sunburn, heatstroke, dehydration, and overheating. The sunny weather and prolonged exposure to harmful UV rays not only impact the individuals travelling in the vehicle but also cause damage to the upholstery which can be incredibly expensive to repair and replace. Furthermore, when the vehicle is exposed to sunlight for a long time, it becomes extremely difficult and uncomfortable for the users to sit inside the vehicle due to the amount of heat present in the vehicle seats as well as for the overall internal temperature of the cabin.

Further, in rainy or snowy weather conditions, individuals travelling in open roof cars can easily get wet with no options to protect themselves from inclement weather conditions. The seating may retain water in rainy weather, thereby making it uncomfortable for the individuals to sit in the vehicles.

Various solutions have been implemented to overcome the problems associated with open roof vehicles, however, the solutions are ineffective. For example, some individuals cover their vehicle's roof with temporary tarps, to protect themselves and the vehicle's interior from sunlight or rain, however, the tarp/covering is easily damaged when exposed to inclement weather conditions and therefore fails to protect the individuals travelling in the vehicle or the vehicle's interior. Also, the existing solutions do not go well with the aesthetics of the open roof vehicles, and therefore, individuals are quite reluctant to use temporary coverings or other similar solutions.

Therefore, there exists a long-felt need in the art for a mounted shade device for vehicles with no top area to adequately protect the individuals inside from inclement weather conditions. There is also a long-felt need in the art for a mounted shade device for open roof vehicles that prevents the individuals travelling in it from harmful effects of exposure to sunlight and therefore prevents them from suffering from heat stroke, dehydration, sunburn, or the like. Additionally, there is a long-felt need in the art for a mounted shade for open roof vehicles to protect its upholstery from becoming damaged from extreme weather conditions. Moreover, there is a long-felt need in the art for a mounting shade for open roof vehicles that assists in dispersing water (i.e., waterproof). Further, there is a long-felt need in the art for a mounting shade for open roof vehicles that blocks direct sunlight from reaching inside the vehicle and ensures the passengers can comfortably sit inside the vehicle. Furthermore, there is a long-felt need in the art for a mounting device for open roof vehicles that increases the shade and thereby comforts the travelers when riding in the vehicle. Additionally, there is a long-felt need in the art for a mounting shade for open roof vehicles that significantly prevents an increase in overall cabin temperature as a byproduct of direct sun. Finally, there is a long-felt need in the art for a mounting shade device for open roof vehicles that is effective, easy to use, and maintains the aesthetics of the open roof vehicles.

The subject matter disclosed and claimed herein, in one embodiment thereof, comprises a vehicle mounted camouflage shade device for an open-top vehicle. The shade device features a top camouflage netting layer and a base netting layer (i.e., mesh netting layer) comprising a mesh liner and/or webbing in checkered pattern, as required, the base netting layer is sewn to the top camouflage netting layer and maintains airflow through the shade device, a webbing frame is sewn along the periphery of the top camouflage netting layer and the base netting layer for providing support to the shade, each attachment point may include but is not limited to a plurality of straps extending outwardly from the webbing frame of which each strap may include an adjustable buckle, hook and loop, and/or a fastener at a free end for securing the shade device to the vehicle, and a plurality of grommets integrated into the webbing frame and configured to receive bungee cords, ropes, straps, or hooks for securing the shade to the vehicle. The shade device prevents direct sunlight from passing through while also allowing air to pass therethrough.

In this manner, the vehicle mounted camouflage shade device of the present invention accomplishes all of the foregoing objectives and provides users with a novel shade device for vehicles for on-highway and off-highway use, such as ATVs, UTVs, Jeeps, and other vehicles of the like with open tops. The shade device prevents excessive sunlight from penetrating the vehicle while maintaining an optimum airflow. The shade device helps prevent damage to vehicle interiors and upholstery by limiting UV ray exposure. The shade device can be easily installed and removed and does not cause permanent changes in the aesthetics of the vehicle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle mounted camouflage shade device for an open-top vehicle. The shade device includes a top camouflage netting layer made of tear-resistant (commonly referred to as ‘rip stop’) and mold resistant material, a base layer comprising a mesh liner and/or webbing in checkered pattern, as required, the base netting layer is coupled to the top camouflage netting layer and maintains airflow through the shade device, a webbing frame is sewn along the periphery of the top camouflage netting layer and the base mesh netting layer, each attachment point may include but is not limited to a plurality of straps extending outwardly from the webbing frame of which each strap may include an adjustable buckle, hook and loop, and/or a fastener at a free end for securing the shade device to the vehicle, and a plurality of grommets integrated into the webbing frame and configured to receive bungee cords, ropes, straps, or hooks for securing the shade to the vehicle. It is to be appreciated that the base layer can be a netting layer coated with an anti-microbial coating.

In yet another embodiment, a vehicle mounted camouflage shade device for an open-top vehicle is disclosed. The shade device further comprises a top camouflage netting layer, the top layer includes a plurality of panels (selectively removable), a base layer comprising a mesh liner and/or webbing in checkered pattern, as required sewn to the top camouflage netting, a webbing frame attached along the periphery of the coupled top and base layers, sewn using single stitching, double stitching, box stitching, and the like and a plurality of attachment mechanisms including straps with adjustable buckles, straps with hook and loop, hook-and-loop fasteners, and grommets configured for securing the shade device to the vehicle.

In another embodiment, a method of protecting the interior of an open-top vehicle from weather elements is described. The method includes the steps of providing a camouflage shade device comprising a top camouflage netting layer, a base layer comprising a mesh liner and/or webbing in checkered pattern, as required, a webbing frame along the periphery, and a plurality of attachment mechanisms including but not limited to straps, hook and loop, grommets, and bungees, positioning the camouflage shade device over the open top of the vehicle with the base mesh netting layer facing the vehicle, securing the camouflage shade device to the vehicle by wrapping the straps around structural components of the vehicle such as a roll bar, and/or threading bungee cords through the grommets and installing them on the vehicle to maintain tension and stability of the shade device.

In another aspect, the top camouflage netting layer can comprise multiple independent panels, each panel is configured to be independently (i.e., selectively) removable from the shade device. The vehicle mounted camouflage shade device may have additional sewn passes spanning from one end to the other, aiding to suppress wind noise as well as device movement (i.e., flap).

In yet another aspect, the grommets are made of a corrosion-resistant material for enhanced durability in various environmental conditions.

In yet another embodiment, the webbing frame is from 1 inch to 5 inches in width and is reinforced with additional stitching at the corners and high-stress points.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of vehicle mounted camouflage shade device of the present invention in accordance with one embodiment of the disclosed structure;

FIG. 2A illustrates a cross-sectional view of the vehicle mounted camouflage shade device of FIG. 1 in accordance with the disclosed structure;

FIG. 2B illustrates an enlarged view of the underside showing a strap sewn to the webbing in accordance with one embodiment of the disclosed structure;

FIG. 3A illustrates an enlarged view of the webbing showing a strap sewn to the webbing in accordance with the disclosed structure

FIG. 3B illustrates an enlarged view showing the underside of the camouflage shade device with a base layer of webbing in a checkered pattern in accordance with one embodiment of the disclosed structure;

FIG. 4 illustrates a perspective view showing the camouflage shade device mounted to a vehicle in accordance with one embodiment of the disclosed structure; and

FIG. 5 illustrates another perspective view showing the installation of the shade device of the present invention on the vehicle in accordance with one embodiment the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a mounted shade device for vehicles with no top area to adequately protect the individuals inside from inclement weather conditions. There is also a long-felt need in the art for a mounted shade device for open roof vehicles that prevents the individuals travelling in it from harmful effects of exposure to sunlight and therefore prevents them from suffering from heat stroke, dehydration, sunburn, or the like. Additionally, there is a long-felt need in the art for a mounted shade for open roof vehicles to protect its upholstery from becoming damaged from extreme weather conditions. Moreover, there is a long-felt need in the art for a mounting shade for open roof vehicles that assists in dispersing water (i.e., water resistant or waterproof). Further, there is a long-felt need in the art for a mounting shade for open roof vehicles that blocks the sunlight from reaching inside the vehicle and ensures the passengers can comfortably sit inside the vehicle. Furthermore, there is a long-felt need in the art for a mounting device for open roof vehicles that increases the shade and thereby comforts the travelers when riding in the vehicle. Additionally, there is a long-felt need in the art for a mounting shade for open roof vehicles that significantly prevents an increase in overall cabin temperature as a byproduct of direct sun. Finally, there is a long-felt need in the art for a mounting shade device for open roof vehicles that is effective, easy to use, and maintains the aesthetics of the open roof vehicles.

The present invention, in one exemplary embodiment, is a vehicle mounted camouflage shade device for an open-top vehicle. The shade device comprises a top camouflage netting layer, a base layer comprising mesh liner and/or webbing in checkered pattern is sewn to the top camouflage netting, a webbing frame is attached along the periphery of the coupled top and base layers and sewn using single stitching, double stitching, box stitching, and similar. A plurality of attachment mechanisms including straps with adjustable buckles, straps with hook and loop, hook-and-loop fasteners, and grommets are configured for securing the shade device to the vehicle. It is to be appreciated that the top layer can comprise a plurality of independent and interconnected panels.

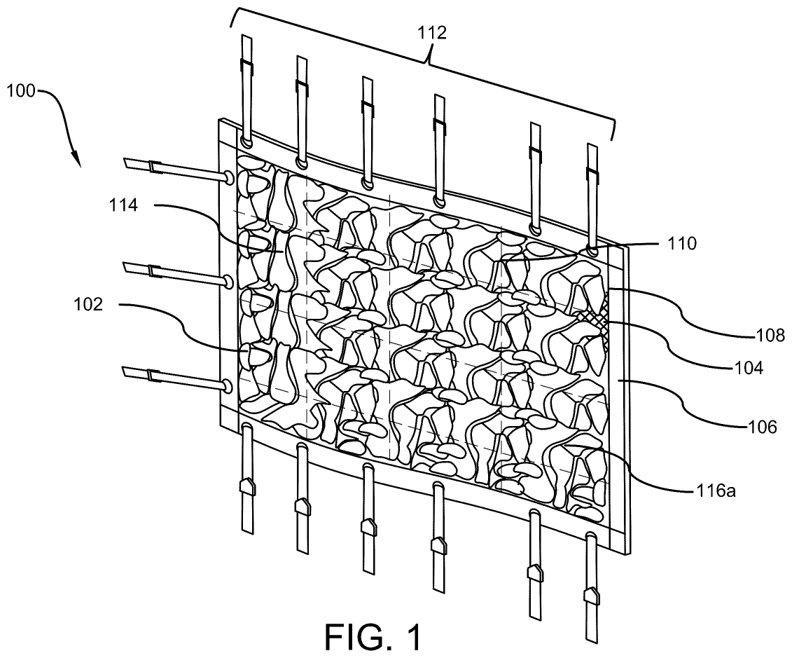

Referring initially to the drawings, FIG. 1 illustrates a perspective view of vehicle mounted camouflage shade device of the present invention in accordance with one embodiment the disclosed structure. The vehicle mounted camouflage shade device 100 is designed to be mounted on vehicles with open tops for on-highway and off-highway use, such as ATVs, UTVs, Jeeps, and others of the like to cover the vehicle top and help prevent excessive sunlight from penetrating the interior of the vehicle. More specifically, the vehicle mounted camouflage shade device 100 has a multilayered construction and includes a top camouflage netting layer 102 adapted to provide visual camouflage and an initial layer of shading. The camouflage layer 102 is lightweight and is adapted to dry easily to resist rot and mold. Preferably, the layer 102 is made of tear-resistant (commonly referred to as ‘rip stop’) material such as strong oxford fabric or any other synthetic material and is treated with a UV-resistant coating.

A base or bottom layer 104 of the shade device 100 is made of mesh netting. In one embodiment, the mesh netting is coated with an anti-microbial coating to prevent mold and mildew growth. The base or bottom layer 104 is adapted to maintain airflow through the shade device 100 and enhances durability of the shade device 100. The vehicle mounted shade device 100 includes a sturdy webbing 106 along the periphery 108 for providing a frame to maintain shape of the shade device 100. The webbing 106 can range from 1″ to 5″ in width and preferably is 3″ in width. The top layer 102 and the base or bottom layer 104 are stitched together along a plurality of edges 110 for securely bonding the top camouflage netting 102 and the base mesh netting 104, providing a unified and durable structure to the shade device 100. The webbing 106 is sewn onto the edges of the layers 102, 104 using a strong, durable stitch, such as a double stitch or a box stitch, and the stitching runs along the entire perimeter of the shade device 100.

The vehicle mounted camouflage shade device 100 is designed to substantially cover the open top of a vehicle and is secured to the frame of the vehicle using a plurality of fasteners. As illustrated, a plurality of straps 112 extend outwardly from the webbing 106 to secure the device 100 to a vehicle (only a set of straps are numbered as 112 for brevity purposes). The shade device 100 is preferably rectangular or square but can be of any geometric shape and size to meet requirements of designs of different vehicles. In one application, the camouflage netting 102 can be designed as a single panel or can also be designed in a plurality of independent panels 114 wherein a panel (for example, 116a) can be independently (i.e., selectively) removed. The camouflage pattern on the top netting layer 102 can be a 2D layer or a 3D layer and can come in different colors and patterns.

The device 100 protects passengers of the vehicle from direct sunlight, thereby reducing heat buildup and potential sunburn. The combination of camouflage netting 102 and mesh netting 104 allows air to flow freely, keeping the interior of the vehicle cool and comfortable.

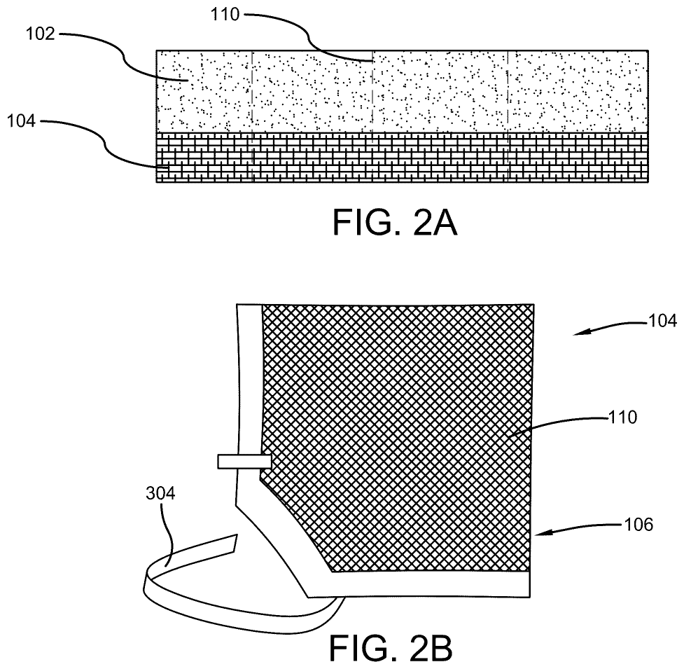

FIG. 2A illustrates a cross-sectional view of the vehicle mounted camouflage shade device of FIG. 1. in accordance with the disclosed structure. The top camouflage netting layer 102 has a thickness from about 0.005″ to about 2.000″ in different embodiments and the base or bottom layer 104 can have a thickness from about 0.02″ to about 0.10″. The layers 102, 104 are sewn at a plurality of edges 110 for securing the layers together and to give a one-piece construction to the shade device 100.

FIG. 2B illustrates an enlarged view of the underside of the vehicle mounted camouflage shade device in accordance with the disclosed structure. The top camouflage netting layer 102 has a thickness from about 0.005″ to about 2.000″ in different embodiments and the base or bottom layer 104 can have a thickness from about 0.02″ to about 0.10″. The layers 102, 104 are sewn at a plurality of edges 110 for securing the layers together and to give a one-piece construction to the shade device 100. As illustrated, a strap 304 with hook and loop is attached to the webbing 106. In a separate location of FIG. 2B, hook and loop is directly sewn into the webbing 106 of shade device 100.

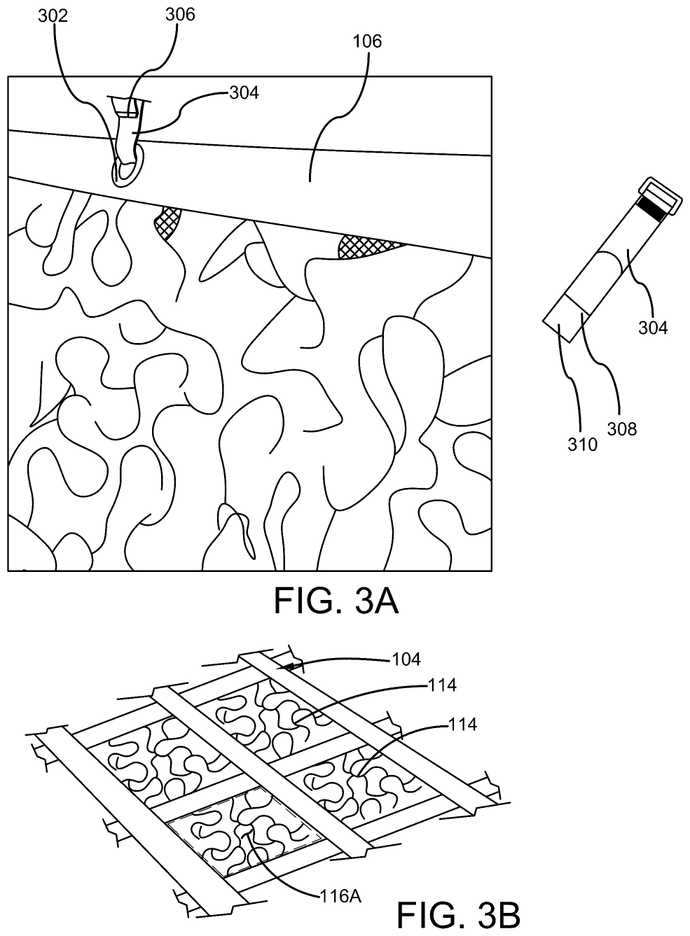

FIG. 3A illustrates an enlarged view of the webbing showing a strap installed into webbing in accordance with the disclosed structure. A plurality of straps with buckles and other fasteners are sewn to the webbing 106 for securing the shade device 100 to the frame of a vehicle. As illustrated, a grommet 302 is installed into the webbing 106, and a strap 304 is secured to the webbing 106 and is supported by the grommet 302. The strap 304 includes an adjustable buckle 306 for adjusting the length of the strap 304 and a fastener 308 such as a hook and loop fastener or any other mechanical fastener is disposed on the free end 310 of the strap 304. The grommet 302 is adapted to remain firmly attached to the webbing 106 under tension on the strap 304 for secure positioning of the shade device 100. The grommet 302 can also be used for threading bungee cords, ropes, or hooks therethrough. The grommets used in the shade device 100 are preferably made of a corrosion-resistant material.

FIG. 3B illustrates an enlarged view showing the underside of the camouflage shade device with a base layer of webbing in checkered pattern in accordance with one embodiment of the disclosed structure. As illustrated, the vehicle mounted shade device is shown upside-down to better illuminate one option of base layer 104 as webbing sewn in a checkered pattern. The base layer as checkered webbing is preferably rectangular or square but can be of any geometric shape and size to meet requirements of designs of different vehicles. In one application, the camouflage netting 102 can be designed as a single panel or can also be designed in a plurality of independent panels 114 wherein a panel (for example, 116a) can be independently (i.e., selectively) removed as per preferences of a user.

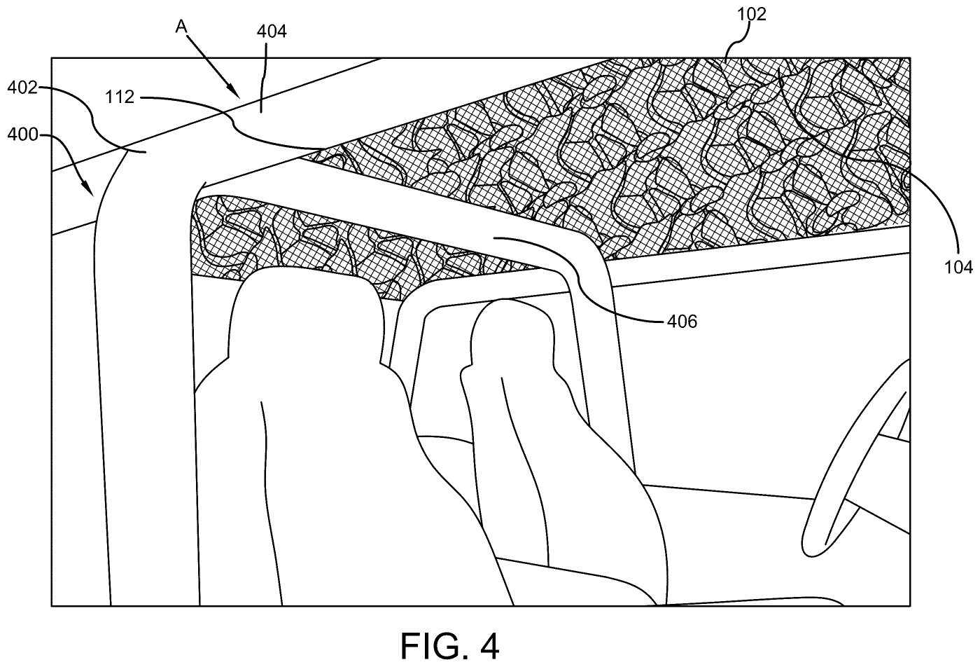

FIG. 4 illustrates a perspective view showing the camouflage shade device mounted to a vehicle in accordance with one embodiment of the disclosed structure. The shade device 100 is placed on the frame 402 of a vehicle 400 such that the base or bottom layer 104 faces the vehicle 400 and the camouflage layer 102 is visible from the top (Arrow A) of the vehicle 400. The straps 112 are stretched and extended and are wrapped around sturdy parts of the vehicle 400 such as roll bars 404, roof racks 406, or other fixed structures.

It will be apparent to a person skilled in the art that the mesh netting 104 allows some light to pass therethrough, thereby providing adequate illumination inside the vehicle 400 without harmful effects of UV rays and sunburn while also allowing airflow. Further, the shade device 100 can be used for protection from other weather elements like rain and snow.

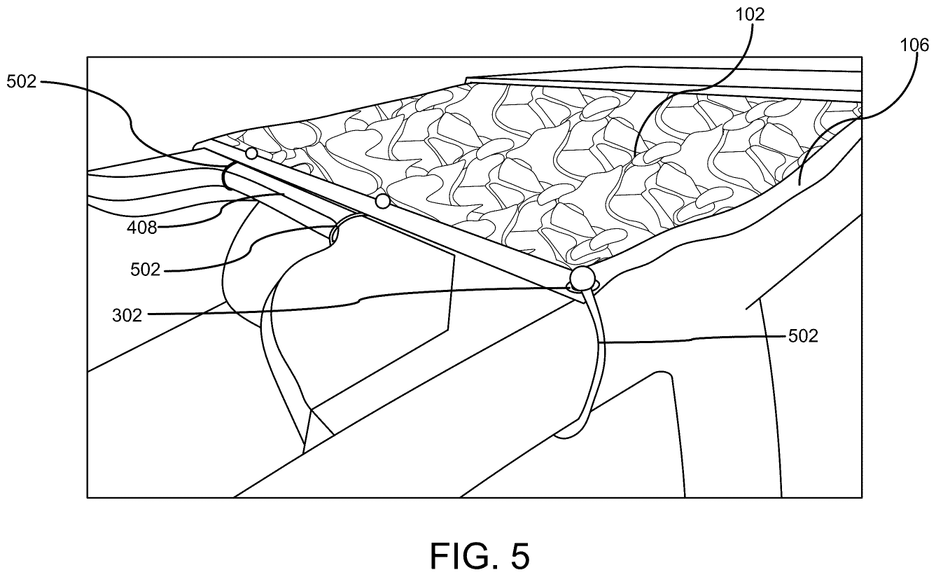

FIG. 5 illustrates another perspective view showing the installation of the shade device of the present invention on the vehicle in accordance with one embodiment of the disclosed structure. As illustrated, a plurality of bungees 502 are used with a plurality of grommets 302 for supporting and securing the shade device 100. The bungees 502 help in keeping the shade device 100 taut and are secured to separate supporting structures 408 of the vehicle 400. The straps, bungees, hook and loop, and grommets along the edges of the shade device 100 help the shade device 100 to be in constant tension and secure attachment with the vehicle 400.

The camouflage shade device 100 does not cause any permanent changes in the vehicle 400 and can be easily installed and removed without any professional help. Further, the shade device 100 is foldable and can be rolled for secure storage and transportation. The grommets and straps can further be supported using box stitching for even distribution of stress and tension.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “camouflage shade device”, “vehicle mounted camouflage shade device”, “vehicle mounted multi-layer camouflage shade device”, and “shade device” are interchangeable and refer to the vehicle mounted multi-layer camouflage shade device 100 of the present invention.

Notwithstanding the foregoing, the vehicle mounted multi-layer camouflage shade device 100 of the present invention can be of any suitable size and configuration as is known in the art without affecting the overall concept of the invention, provided that it accomplishes the above-stated objectives. One of ordinary skill in the art will appreciate that the vehicle mounted multi-layer camouflage shade device 100 as shown in the FIGS. are for illustrative purposes only, and that many other sizes and shapes of the vehicle mounted multi-layer camouflage shade device 100 are well within the scope of the present disclosure. Although the dimensions of the vehicle mounted multi-layer camouflage shade device 100 are important design parameters for user convenience, the vehicle mounted multi-layer camouflage shade device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle mounted camouflage shade device comprising:
a multilayered cover;
a top layer;
a bottom layer;
a webbing;
a plurality of straps; and
a plurality of fasteners;
wherein said top layer having a camouflage netting layer;
wherein said bottom layer having a netting webbing in a checkered pattern;
wherein said top layer stitched to said bottom layer along a plurality of edges for bonding said camouflage netting layer to said netting webbing;
wherein said camouflage netting layer is selected from the group consisting of a 2D layer and a 3D layer;
wherein said webbing sewn to perimeter edges of said bottom layer and said top layer;
wherein said plurality of straps connected to said plurality of fasteners; and
further wherein said plurality of fasteners secured to a frame of the vehicle.

2. The vehicle mounted camouflage shade device of claim 1, wherein said top layer having a plurality of panels.

3. The vehicle mounted camouflage shade device of claim 2, wherein each one of said plurality of panels selectively removable.

4. The vehicle mounted camouflage shade device of claim 3, wherein said webbing having a width from 1″ to 5″.

5. The vehicle mounted camouflage shade device of claim 4, wherein said camouflage netting layer having a thickness from 0.005″ to 2.000″.

6. The vehicle mounted camouflage shade device of claim 5, wherein said bottom layer having a thickness from 0.02″ to 0.10″.

7. The vehicle mounted camouflage shade device of claim 6 further comprising a plurality of grommets affixed into said webbing, wherein each one of said plurality of fasteners are secured to one of said plurality of grommets.

8. The vehicle mounted camouflage shade device of claim 7, wherein said plurality of fasteners having hook and loop fasteners.

9. The vehicle mounted camouflage shade device of claim 7, wherein the vehicle is selected from the group consisting of an ATV, a UTV, and a Jeep.

10. The vehicle mounted camouflage shade device of claim 7, wherein said top layer having tear-resistant material.

11. The vehicle mounted camouflage shade device of claim 10, wherein said top layer having a UV-resistant coating.

12. A vehicle mounted camouflage shade device comprising:
a multilayered cover;
a top layer;
a bottom layer;
a webbing;
a plurality of straps;
a plurality of elastic bungee cords; and
a plurality of fasteners;
wherein said top layer having a camouflage netting layer;
wherein said bottom layer having a netting webbing layer in a checkered pattern;
wherein said top layer stitched to said bottom layer along a plurality of edges for bonding said camouflage netting layer to said netting webbing layer;
wherein said camouflage netting layer is selected from the group consisting of a 2D layer and a 3D layer;
wherein said webbing sewn to perimeter edges of said bottom layer and said top layer;
wherein said plurality of straps connected to said plurality of fasteners; and
further wherein said plurality of fasteners and said plurality of elastic bungee cords secured to a frame of the vehicle.

13. The vehicle mounted camouflage shade device of claim 12, wherein said top layer having a plurality of panels.

14. The vehicle mounted camouflage shade device of claim 13, wherein each one of said plurality of panels selectively removable.

15. The vehicle mounted camouflage shade device of claim 12, wherein said camouflage netting layer having a thickness from 0.005″ to 2.000″.

16. The vehicle mounted camouflage shade device of claim 15, wherein said bottom layer having a thickness from 0.02″ to 0.10″.

17. The vehicle mounted camouflage shade device of claim 16 further comprising a plurality of grommets affixed into said webbing, wherein each one of said plurality of straps secured to one of said plurality of grommets.

18. The vehicle mounted camouflage shade device of claim 17, wherein the vehicle is selected from the group consisting of an ATV, a UTV, and a Jeep.

19. The vehicle mounted camouflage shade device of claim 17, wherein said top layer having a UV-resistant coating.

20. A vehicle mounted camouflage shade device comprising:
a multilayered cover;
a top layer;
a bottom layer;
a webbing;
a plurality of straps; and
a plurality of fasteners;
wherein said top layer having a camouflage netting layer;
wherein said bottom layer having a netting webbing layer in a checkered pattern;
wherein said top layer stitched to said bottom layer along a plurality of edges for bonding said camouflage netting layer to said netting webbing layer;
wherein said webbing sewn to perimeter edges of said bottom layer and said top layer;
wherein said plurality of straps connected to said plurality of fasteners;
wherein said plurality of fasteners secured to a frame of the vehicle;
wherein said top layer having a plurality of panels;
wherein each one of said plurality of panels selectively removable; and
further wherein said top layer having a UV-resistant coating.
